(19) United States
(12) Patent Application Publication
(10) Pub. No.: US 2023/0211258 A1
(43) Pub. Date: Jul. 6, 2023

(54) Method and Device for Extracting Clean Liquid from Slurry Reactor

(71) Applicants: Qingdao Institute of Bioenergy and Bioprocess Technology, Chinese Academy of Sciences, Shandong (CN); Institute of Process Engineering, Chinese Academy of Sciences, Beijing (CN)

(72) Inventors: Qingshan Huang, Shandong (CN); Quanhong Zhu, Shandong (CN); Hang Xiao, Shandong (CN); Jingcai Cheng, Beijing (CN); Chao Yang, Beijing (CN)

(21) Appl. No.: 15/734,067

(22) PCT Filed: Aug. 24, 2020
(86) PCT No.: PCT/CN2020/110725

§ 371 Date: Mar. 15, 2023

(51) Int. Cl. B01D 21/02; B01D 19/00; B01J 8/22

(52) U.S. Cl. CPC B01D 21/02; B01D 19/00; B01J 8/22

(57) ABSTRACT

The disclosure provides a device and method for extracting a clean liquid from a slurry reactor in an environment-friendly and energy-saving manner. The method mainly includes the following steps: S1. siphoning slurry in the slurry reactor into a material collecting pipe, and then spraying the slurry into a settling tank, so that solid particles settle in the settling tank and return to the slurry reactor through a discharging pipe; S2. making supernatant in the settling tank flow upward along a settling pipe, and then flow downward at a pipe intersection into a clear liquid pipe and flow into a clear liquid transition tank; S3. discharging liquid from the clear liquid transition tank in an overflow manner to keep the constant liquid level and a pressure required for siphoning; and S4. introducing gas in the material collecting pipe into an escape pipe and continuously discharging the gas to ensure that the liquid level in the escape pipe is always higher than the pipe intersection so as to ensure that the slurry reactor and the clear liquid transition tank are always communicated and the liquid levels are the same. The device according to the disclosure is simple in structure, and the process is simple, safe and reliable, and is not prone to failure. It is easy to implement large-scale continuous operation and adjust separation efficiency and precision. The device requires low equipment investment and is low in operation cost and environmentally friendly.

### TECHNICAL FIELD

The disclosure relates to the technical field of slurry reactors, and in particular, to a method and device for extracting a clean liquid from a slurry reactor.

### BACKGROUND

Compared with a fixed bed reactor, a slurry reactor can use solid particles with a smaller particle size without worrying about excessively high pressure drop in the bed. The use of small particles can significantly reduce the resistance during the internal diffusion step, strengthen the contact mass transfer between liquid and solid, and improve the macro reaction rate. However, the slurry reactor has to deal with how to separate these small particles from liquid products, namely how to extract clean liquid from the slurry reactor. Liquid-solid separation can not only help improve the purity of liquid products, but also improve the utilization efficiency of solid catalyst particles. How to effectively implement large-scale, continuous and efficient liquid-solid separation is a critical technology in the design process of the slurry reactor.

At present, the slurry reactor mainly uses the following three types of liquid-solid separation methods:

1. Method based on filtration separation (including membrane separation). Such methods have the advantages that the separation accuracy is high and almost no solid particles are contained in liquid products. However, the methods also have some disadvantages, especially when high-concentration and small-particle solid catalysts are present. That is, it is challenging to implement continuous operation, and the separated solid particles often need extra power to return to the slurry reactor. In addition, clogging is an unavoidable problem in filtration and separation methods, and limits the industrial application to a great extent. For example, in the invention patent No. CN 102049222 B, although the continuous liquid-solid separation is implemented by cross-flow filtration inside a slurry reactor, the problem of blockage of filter medium channels still occurs.

2. Separation based on a hydrocyclone. For example, in the invention patent No. CN 106635138 B, slurry is introduced into a hydrocyclone, then top flow is extracted as a liquid product, and bottom flow returns to a slurry reactor as a solid. Such methods have the advantages that continuous operations (a clear liquid is continuously extracted and solids continuously return) can be implemented well, and failures do not occur easily. However, such methods have three shortcomings. First, the separation accuracy is not high, and top flow liquid often contains a certain amount of small particles, and often requires secondary separation. Second, in order to improve the speed of slurry entering a hydrocyclone (improve separation efficiency and precision) or to make concentrated bottom flow slurry return to the slurry reactor smoothly, it is often necessary to use an expensive slurry pump to pump slurry, which increases investment costs and operation costs. Third, particles in the slurry pump and the hydrocyclone are seriously worn, which increases the use amount of solid particles. Besides, fine powder generated further increases the difficulty of separation in the next cycle, causing a vicious circle.

3. Separation method based on gravity sedimentation. Compared with the preceding two types of methods, this method may have the advantages of small particle wear and easiness in continuous operation. However, with respect to the conventional gravity sedimentation separation, catalyst particles cannot be excessively small, the concentration should not be excessively high, and the separation is not implemented sufficiently. In addition, it is often necessary to sacrifice a large separation space for higher separation efficiency and accuracy, so that the equipment investment is large. In addition, for the process of sedimentation separation outside the slurry reactor, extra power is still needed to enable solid particles to return to the slurry reactor. In methods of sedimentation separation inside the slurry reactor (such as the invention patent No. CN 102039106 B), continuous liquid-solid separation can be well implemented, solid particles are trapped inside a reactor, and a clear liquid overflows and is discharged. However, for this process of liquid-solid separation inside the slurry reactor, the liquid-solid separation efficiency and precision are not high due to a small sedimentation separation space and a short settling distance. In summary, for the conventional separation method based on gravity sedimentation, the equipment investment and the separation efficiency and separation accuracy are contradictory, and cannot be considered simultaneously.

To sum up, until now, there is still no environment-friendly, energy-saving and simple device or method that can keep high separation efficiency and precision while implementing large-scale continuous liquid operation. Therefore, how to propose a new solution of extracting clean liquid from a slurry reactor to overcome the foregoing technical problems is an urgent problem to be solved in the disclosure.

### SUMMARY

The disclosure provides a method and device for extracting a clean liquid from a slurry reactor in an environment-friendly and energy-saving manner, which can implement large-scale and continuous liquid-solid separation in an energy-saving manner and continuously extract a large number of clear liquid products.

To achieve the above purpose, the disclosure provides the following technical solutions. The disclosure provides a method for extracting a clean liquid from a slurry reactor, including the following steps:

S1: sucking slurry from the slurry reactor into a material collecting pipe, and then spraying the slurry into a settling tank, so that solid particles settle in the settling tank and return to the slurry reactor through a discharging pipe;

S2: making supernatant in the settling tank flow upward along a settling pipe, and then flow downward at a pipe intersection into a clear liquid pipe;

S3: making the supernatant in the clear liquid pipe flow into a clear liquid transition tank, discharging the clean liquid from the clear liquid transition tank in an overflow mode, and collecting the clean liquid by a clean liquid storage tank; and

S4: introducing gas in the material collecting pipe into an escape pipe at the pipe intersection and continuously discharging the gas to ensure that the liquid level in the escape pipe is always higher than the pipe intersection, so that the slurry reactor and the clear liquid transition tank are always communicated and the liquid levels are the same.

Optionally, in step S1, the slurry in the slurry reactor is sucked into the material collecting pipe in a siphon manner.

Optionally, in step S1, the slurry in the material collecting pipe first rises vertically and then falls obliquely, and the particles in the discharging pipe fall vertically; the slurry in the material collecting pipe and the slurry in the discharging pipe have a density difference due to different solid contents, thereby forming a directional circulating flow, so that the settled solid particles can quickly return to the slurry reactor.

Optionally, in step S4, it is necessary to keep the slurry reactor always communicated with the clear liquid transition tank, so that the liquid levels thereof are the same to ensure that the slurry can be siphoned.

Optionally, in step S4, it is necessary to keep the liquid level in the clear liquid transition tank constant, so as to maintain the power required for siphoning.

The disclosure further provides a device for extracting a clean liquid from a slurry reactor which can implement the above method for extracting a clean liquid from a slurry reactor, including a material collecting pipe, a settling tank, a clear liquid transition tank, a clean liquid storage tank and an automatic liquid level control system, where a bottom end of the material collecting pipe is inserted below the liquid level of the slurry reactor, and a top end thereof is bent downwards and communicated with a lower portion of the settling tank; a bottom end of the settling tank is connected to a discharging pipe, and a bottom end of the discharging pipe is inserted below the liquid level of the slurry reactor; a top end of the settling tank is connected to a settling pipe, and the settling pipe is connected to a clear liquid pipe and an escape pipe at the same time to form a pipe intersection; the other end of the clear liquid pipe is inserted below the liquid level of the clear liquid transition tank, and the clear liquid transition tank is connected to the clean liquid storage tank through an overflow pipe; the other end of the escape pipe is connected to the automatic liquid level control system, and the automatic liquid level control system is configured to detect and adjust the liquid level in the escape pipe; and the material collecting pipe is communicated with the settling pipe through a pipeline.

Optionally, the slurry reactor is a liquid-solid two-phase slurry reactor; the top of the liquid-solid two-phase slurry reactor is provided with a feeding valve, the bottom thereof is provided with a liquid distributor, and the liquid distributor is connected to a fresh liquid inlet pipe.

Optionally, the slurry reactor is a gas-liquid-solid three-phase slurry reactor; the top of the gas-liquid-solid three-phase slurry reactor is provided with a feeding valve and a deflating valve, the bottom thereof is provided with a gas distributor, and the gas distributor is connected to a gas inlet pipe; a side of the bottom of the gas-liquid-solid three-phase slurry reactor is connected to a fresh liquid inlet pipe.

Optionally, an inner wall of the gas-liquid-solid three-phase slurry reactor is provided with a baffle, the baffle surrounds a lower end of the material collecting pipe and is submerged below the liquid level, to prevent gas from entering the material collecting pipe, and a bottom end of the baffle is provided with a gap, so that some settled solid can be returned to the main body of the reactor.

Optionally, the settling pipe, the clear liquid pipe and the escape pipe are connected through a tee structure.

The disclosure achieves the following technical effects compared with the prior art. Compared with the existing technical solutions, the new solution of extracting a clean liquid from a slurry reactor provided by the disclosure has the following advantages.

(1) It is easy to implement continuous operation, the clean liquid can be continuously discharged on a large scale, separated solid particles can be continuously and automatically returned, and there is no problem that solid particles accumulate in a settling tank due to interaction.

(2) Slurry enters a liquid-solid separation system according to the siphon principle, which can implement liquid-solid separation and recycling without extra power, and has the advantages of environmental protection and energy saving.

(3) There is basically no problem of particle wear, no fine powder is generated, and separation is implemented sufficiently with high efficiency.

(4) The device is compact in structure and low in investment cost and operation cost.

(5) The process is simple, easy to operate, safe and reliable, and is not prone to failure.

(6) The super gravity formed by the combined action of inertial force and gravity makes it easier to separate particles in the settling tank, and smaller particles can be separated and return to the slurry reactor.

### BRIEF DESCRIPTION OF THE DRAWINGS

To describe the technical solutions in the examples of the disclosure or in the prior art more clearly, the following briefly introduces the accompanying drawings required for describing the examples. Apparently, the accompanying drawings in the following description show merely some examples of the disclosure, and a person of ordinary skill in the art may still derive other accompanying drawings from these accompanying drawings without creative efforts.

FIG. 1 is a schematic diagram of a system for extracting a clean liquid from a liquid-solid two-phase slurry reactor according to the disclosure; and

FIG. 2 is a schematic diagram of a system for extracting a clean liquid from a gas-liquid-solid three-phase slurry reactor according to the disclosure.

Reference numerals in the figures: fresh liquid inlet pipe 1; liquid distributor 2-1; gas distributor 2-2; liquid-solid two-phase slurry reactor 3-1; gas-liquid-solid three-phase slurry reactor 3-2; material collecting pipe 4; discharging pipe 5; settling tank 6; tee structure 7; clear liquid pipe 8; clear liquid transition tank 9; clean liquid storage tank 10; escape pipe 11; automatic liquid level control system 12; liquid level detection and analysis system 13; suction pump 14; feeding valve 15; settling pipe 16; deflating valve 17; gas inlet pipe 18; baffle 19; overflow pipe 20; pipeline 21.

### DETAILED DESCRIPTION

The following clearly and completely describes the technical solutions in the examples of the disclosure with reference to accompanying drawings in the examples of the disclosure. Apparently, the described examples are merely some rather than all of the examples of the disclosure. All other examples obtained by a person of ordinary skill in the art based on the examples of the disclosure without creative efforts shall fall within the protection scope of the disclosure.

In order to make the foregoing objectives, features, and advantages of the disclosure more understandable, the disclosure will be further described in detail below with reference to the accompanying drawings and specific implementations.

### EXAMPLE 1

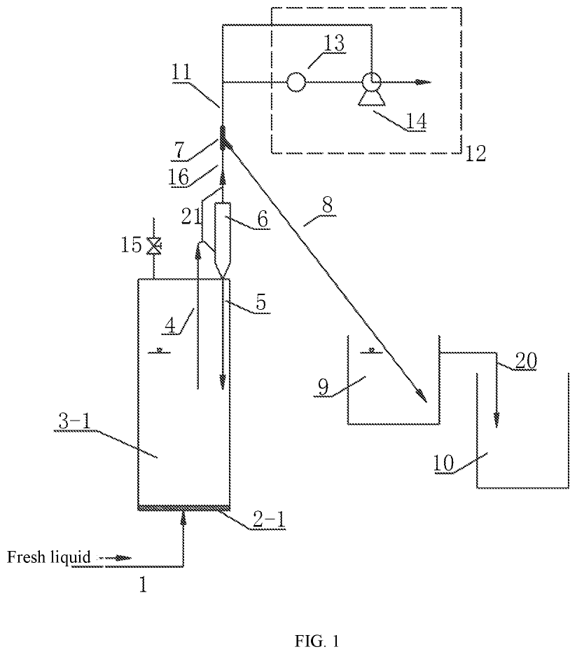

As shown in FIG. 1, this example provides a method for extracting a clean liquid from a slurry reactor, mainly including the following steps.

(1) Siphon slurry in the slurry reactor into a material collecting pipe, and then spray the slurry into a settling tank, so that solid particles settle in the settling tank and return to the slurry reactor through a discharging pipe. Because the density difference is caused by different solid concentrations of slurry in the material collecting pipe and slurry in the discharging pipe, the directional circular flow of the slurry is implemented in the material collecting pipe and the discharging pipe. This facilitates liquid-solid separation by using super gravity, and also makes the settled solids in the settling tank quickly and automatically return to the slurry reactor through the discharging pipe. Therefore, it solves the problem that it is difficult for solid catalysts to return because solid particles settle on an upper portion of the discharging pipe due to the acting force between the particles and the particles settle slowly in the discharging pipe due to slurry rise.

(2) Make supernatant in the settling tank flow upward along a settling pipe, perform gravity sedimentation for enough time, and make the supernatant flow downward at a tee into a clear liquid pipe and flow into a clear liquid transition tank.

(3) Liquid overflowing from the clear liquid transition tank is the required clean liquid. Collect the liquid by a clean liquid storage tank, and discharge liquid in an overflow manner to keep the liquid level in the clear liquid transition tank constant, thereby keeping power required for siphoning.

(4) Make gas entering the material collecting pipe or gas escaped from the liquid move upwards in the form of small bubbles, introducing, at the tee upwards, the gas into an escape pipe and continuously discharge the gas to ensure that the liquid level in the escape pipe is always higher than that in the tee, so as to ensure that the slurry reactor and the clear liquid transition tank are always communicated with each other and the liquid levels thereof are the same.

In this example, a lower end of the material collecting pipe needs to be inserted below the liquid level in the slurry reactor, an upper end thereof is connected to the settling tank, an upper end of the settling tank is connected to an upper end of the clear liquid pipe and a lower end of the escape pipe through the tee, and a lower end of the clear liquid pipe needs to be inserted below the liquid level in the clear liquid transition tank.

In this example, the liquid level in the escape pipe should always be higher than that in the tee, so as to ensure that the slurry reactor and the clear liquid transition tank are always communicated and the liquid level is dynamically balanced, thereby creating conditions for the smooth siphoning.

In this example, the clean liquid in the clear liquid transition tank is discharged into the clean liquid storage tank through an overflow pipe, so as to keep the constant liquid level and the power required for siphoning.

In this example, the upper end of the material collecting pipe should be inclined downward or face the discharging pipe, so that the slurry is sprayed downward into the lower portion of the settling tank. Due to the large inertia difference between the solid and the liquid, the liquid-solid super-gravity separation is performed under the dual action of inertia force and gravity, and the concentrated slurry forms a fixed directional circular flow between the material collecting pipe and the discharging pipe. This makes the solid particles quickly return to the slurry reactor after separation.

In this example, a cone angle of an inverted cone section in the settling tank should be reasonably set to prevent the particles from accumulating and slipping freely.

In this example, the separation accuracy can be changed by adjusting the size of the settling pipe.

The extraction of a clean liquid from a liquid-solid two-phase slurry reactor is taken as an example below to specifically describe the extraction method and the corresponding extraction device of this example.

As shown in FIG. 1, in a liquid-solid two-phase slurry reactor 3-1, a lower end of a material collecting pipe 4 is inserted below the liquid level in the liquid-solid two-phase slurry reactor 3-1, an upper end thereof is bent downward and communicated with a lower portion of a settling tank 6, a lower end of the settling tank 6 is connected to an upper end of a discharging pipe 5, and a lower end of the discharging pipe 5 is also inserted below the liquid level in the liquid-solid two-phase slurry reactor 3-1. An upper end of the settling tank 6 is connected to a tee structure 7, an upper end of a clear liquid pipe 8 and a lower end of an escape pipe 11 through a settling pipe 16 to form a pipe intersection. A lower end of the clear liquid pipe 8 is inserted below the liquid level of a clear liquid transition tank 9, the clear liquid transition tank 9 is connected to a clean liquid storage tank 10 through an overflow pipe 20, and liquid in the clear liquid transition tank 9 can flow into the clean liquid storage tank 10 in an overflow mode. An upper end of the escape pipe 11 is connected to an automatic liquid level control system 12, and the automatic liquid level control system 12 is mainly composed of a liquid level detection and analysis system 13 and a suction pump 14. Besides, an upper portion of the material collecting pipe 4 is also provided with a pipeline 21 communicated with the settling pipe 16.

Solid particles are added into the liquid-solid two-phase slurry reactor 3-1 through a feeding valve 15, and then the clear liquid transition tank 9 is filled with the clean liquid until the clean liquid reaches an overflow port; then fresh liquid enters the liquid-solid two-phase slurry reactor 3-1 through a pipe 1 and a liquid distributor 2-1. After the liquid level reaches a target value, an automatic liquid level control system 12 is started, and the liquid level in the escape pipe 11 is within the target range under the pumping action of the suction pump 14. In this case, the material collecting pipe 4, the settling tank 6, the discharging pipe 5, the settling pipe 16, the clear liquid pipe 8 and the pipeline 21 are filled with the liquid, so that the liquid-solid two-phase slurry reactor 3-1 and the clear liquid transition tank 9 are communicated, and the liquid levels thereof are the same. Then, in the process of fresh liquid entering the liquid-solid two-phase slurry reactor 3-1, slurry in the liquid-solid two-phase slurry reactor 3-1 is siphoned into the material collecting pipe 4 and then sprayed into the settling tank 6, and the solid particles quickly settle and return to the liquid-solid two-phase slurry reactor 3-1 through the discharging pipe 5. Supernatant in the settling tank 6 flows upward along the settling pipe and is further subjected to gravity sedimentation, flows downwards at the tee structure 7 into the clear liquid pipe 8, and finally flows into the clear liquid transition tank 9. Through overflow, the clear liquid transition tank 9 keeps the constant liquid level and power required for siphoning, and the liquid that overflows flows into the clean liquid storage tank 10.

Gas entering the material collecting pipe 4 or gas escaped from the liquid moves upwards along the pipeline 21 and the settling pipe 16 in the form of small bubbles, and is introduced at the tee structure 7 to enter the escape pipe 11, causing the liquid level in the escape pipe 11 to decrease gradually. If this part of gas cannot be discharged in time, the liquid level in the escape pipe 11 will drop continuously. This eventually results in that the material collecting pipe 4 is no longer communicated with the clear liquid pipe 8, the liquid-solid two-phase slurry reactor 3-1 is no longer communicated with the clear liquid transition tank 9, and the slurry in the liquid-solid two-phase slurry reactor 3-1 cannot be siphoned into the material collecting pipe 4. Therefore, the automatic liquid level control system 12 is set herein. When detecting that the liquid level in the escape pipe 11 drops to a lower limit, the liquid level detection and analysis system 13 sends an instruction to start the suction pump 14, so that the liquid level in the escape pipe 11 rises gradually. When detecting that the liquid level in the escape pipe 11 reaches an upper limit, the liquid level detection and analysis system 13 sends an instruction to shut down the suction pump 14. In this way, the liquid level in the escape pipe 11 can fluctuate between the upper limit and the lower limit, so that the liquid-solid two-phase slurry reactor 3-1 and the clear liquid transition tank 9 are always communicated with each other, and the liquid levels thereof are always the same. Besides, solid particles are always trapped in the liquid-solid two-phase slurry reactor 3-1. This can significantly improve the utilization efficiency.

It should be noted that the liquid level detection and analysis system 13 and the suction pump 14 are electrically connected, and are existing structural components. For example, the liquid level detection and analysis system 13 may be composed of signal connection between an existing liquid level detector and a micro-control system. The specific structures and working principles of the liquid level detection and analysis system 13 and the suction pump 14 pertain to the prior art and subject to the implementation of solution functions of this example, which will not be described in detail here.

### EXAMPLE 2

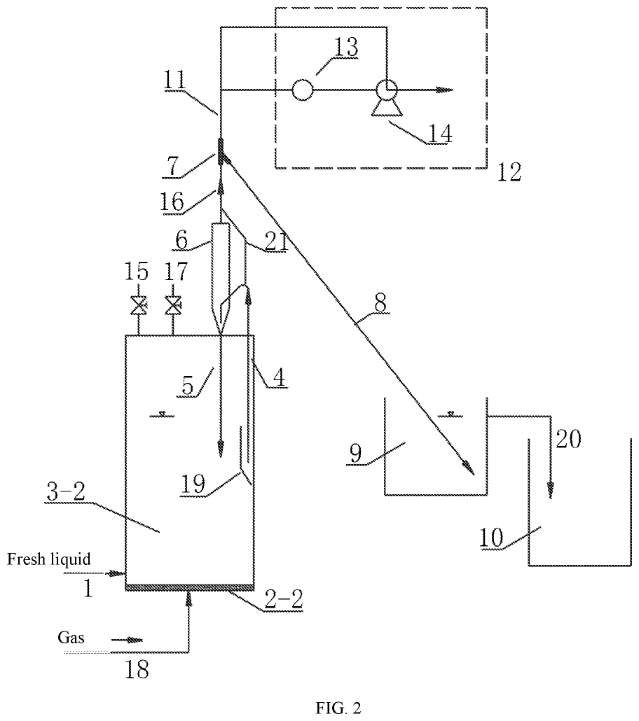

As shown in FIG. 2, this example provides a method for extracting a clean liquid from a slurry reactor, mainly including the following steps.

(1) Siphon slurry in the slurry reactor into a material collecting pipe, and then spray the slurry into a settling tank, so that solid particles settle in the settling tank and return to the slurry reactor through a discharging pipe. Because the density difference is caused by different solid concentrations of slurry in the material collecting pipe and slurry in the discharging pipe, the directional circular flow of the slurry is implemented in the material collecting pipe and the discharging pipe. This facilitates liquid-solid separation by using super gravity, and also makes the settled solids in the settling tank quickly and automatically return to the slurry reactor through the discharging pipe. Therefore, it solves the problem that it is difficult for solid catalysts to return because solid particles settle on an upper portion of the discharging pipe due to the acting force between the particles and the particles settle slowly in the discharging pipe due to slurry rise.

(2) Make supernatant in the settling tank flow upward along a settling pipe, perform gravity sedimentation for enough time, and make the supernatant flow downward at a tee into a clear liquid pipe and flow into a clear liquid transition tank.

(3) Liquid overflowing from the clear liquid transition tank is the required clean liquid. Collect the liquid by a clean liquid storage tank, and discharge liquid in an overflow manner to keep the liquid level in the clear liquid transition tank constant, thereby keeping power required for siphoning.

(4) Make gas entering the material collecting pipe or gas escaped from the liquid move upwards in the form of small bubbles, introducing, at the tee upwards, the gas into an escape pipe and continuously discharge the gas to ensure that the liquid level in the escape pipe is always higher than that in the tee, so as to ensure that the slurry reactor and the clear liquid transition tank are always communicated with each other and the liquid levels thereof are the same.

In this example, a lower end of the material collecting pipe needs to be inserted below the liquid level in the slurry reactor, an upper end thereof is connected to the settling tank, an upper end of the settling tank is connected to an upper end of the clear liquid pipe and a lower end of the escape pipe through the tee, and a lower end of the clear liquid pipe needs to be inserted below the liquid level in the clear liquid transition tank.

In this example, the liquid level in the escape pipe should always be higher than that in the tee, so as to ensure that the slurry reactor and the clear liquid transition tank are always communicated and the liquid level is dynamically balanced, thereby creating conditions for the smooth siphoning.

In this example, the clean liquid in the clear liquid transition tank is discharged into the clean liquid storage tank through an overflow pipe, so as to keep the constant liquid level and the power required for siphoning.

In this example, the upper end of the material collecting pipe should be inclined downward or face the discharging pipe, so that the slurry is sprayed downward into the lower portion of the settling tank. Due to the large inertia difference between the solid and the liquid, the liquid-solid super-gravity separation is performed under the dual action of inertia force and gravity, and the concentrated slurry forms a fixed directional circular flow between the material collecting pipe and the discharging pipe. This makes the solid particles quickly return to the slurry reactor after separation.

In this example, a cone angle of an inverted cone section in the settling tank should be reasonably set to prevent the particles from accumulating and slipping freely.

In this example, the separation accuracy can be changed by adjusting the size of the settling pipe.

The extraction of a clean liquid from a gas-liquid-solid three-phase slurry reactor is taken as an example below to specifically describe the extraction method and the corresponding extraction device of this example.

As shown in FIG. 2, in a gas-liquid-solid three-phase slurry reactor 3-2, a lower end of a material collecting pipe 4 is inserted below the liquid level in the gas-liquid-solid three-phase slurry reactor 3-2, an upper end thereof is bent downward, is opposite to the discharging pipe 5 and is communicated with a settling tank 6, a lower end of the settling tank 6 is connected to an upper end of a discharging pipe 5, and a lower end of the discharging pipe 5 is also inserted below the liquid level of the gas-liquid-solid three-phase slurry reactor 3-2. An upper end of the settling tank 6 is connected to a tee structure 7, an upper end of a clear liquid pipe 8 and a lower end of an escape pipe 11 through a settling pipe 16. A lower end of the clear liquid pipe 8 is inserted below the liquid level of a clear liquid transition tank 9, and the liquid in the clear liquid transition tank 9 can flow into the clean liquid storage tank 10 through an overflow pipe 20 in an overflow mode. An upper end of the escape pipe 11 is connected to an automatic liquid level control system 12, and the automatic liquid level control system 14 is composed of a liquid level detection and analysis system 13 and a suction pump 14. Besides, an upper portion of the material collecting pipe 4 is also provided with a pipeline 21 communicated with the settling pipe 16.

Solid particles are added into the gas-liquid-solid three-phase slurry reactor 3-2 through a feeding valve 15, and then the clear liquid transition tank 9 is filled with the clean liquid until the clean liquid reaches an overflow port; then gas enters the gas-liquid-solid three-phase slurry reactor 3-2 through a gas inlet pipe 18 and a gas distributor 2-2; besides, fresh liquid enters the gas-liquid-solid three-phase slurry reactor 3-2 through a pipe 1. After the liquid level in the gas-liquid-solid three-phase slurry reactor 3-2 reaches a target value, an automatic liquid level control system 12 is started, and the liquid level in the escape pipe 11 is within the target range under the pumping action of the suction pump 14. In this case, the material collecting pipe 4, the settling tank 6, the discharging pipe 5, the settling pipe 16, the clear liquid pipe 8 and the pipeline 21 are filled with the liquid, so that the gas-liquid-solid three-phase slurry reactor 3-2 and the clear liquid transition tank 9 are communicated, and the liquid levels thereof are the same. Then, in the process of the gas and fresh liquid pumping into the gas-liquid-solid three-phase slurry reactor 3-2, exhaust is discharged through a deflating valve 17, while the slurry in the gas-liquid-solid three-phase slurry reactor 3-2 is siphoned into the material collecting pipe 4 and then sprayed into the settling tank 6. The solid particles quickly settle and return to the gas-liquid-solid three-phase slurry reactor 3-2 under the action of super gravity composed of inertial force and gravity. Supernatant in the settling tank continues to move upward and is further subjected to gravity sedimentation, flows downwards at the tee structure 7 into the clear liquid pipe 8, and finally flows into the clear liquid transition tank 9. Through overflow, the clear liquid transition tank 9 keeps the constant liquid level and power required for siphoning, and the liquid that overflows enters the clean liquid storage tank 10.

Gas entering the material collecting pipe 4 or gas escaped from the liquid moves upwards along the pipeline 21 and the settling pipe 16 in the form of small bubbles, and is introduced at the tee structure 7 to enter the escape pipe 11, causing the liquid level in the escape pipe 11 to decrease gradually. If this part of gas cannot be discharged in time, the liquid level in the escape pipe 11 will drop continuously. This eventually results in that the material collecting pipe 4 is no longer communicated with the clear liquid pipe 8, and the slurry in the gas-liquid-solid three-phase slurry reactor 3-2 cannot be siphoned into the material collecting pipe 4. Therefore, the automatic liquid level control system 12 is set herein. When detecting that the liquid level in the escape pipe 11 drops to a lower limit, the liquid level detection and analysis system 13 sends an instruction to start the suction pump 14, so that the liquid level in the escape pipe 11 rises gradually. When detecting that the liquid level in the escape pipe 11 reaches an upper limit, the liquid level detection and analysis system 13 sends an instruction to shut down the suction pump 14. In this way, the liquid level in the escape pipe 11 can fluctuate between the upper limit and the lower limit, so that the gas-liquid-solid three-phase slurry reactor 3-2 and the clear liquid transition tank 9 are always communicated with each other. Besides, solid particles are always trapped in the gas-liquid-solid three-phase slurry reactor 3-2. This can significantly improve the utilization efficiency. The separation accuracy can be effectively changed by adjusting the size of the settling pipe 16.

In addition, the following measures can be taken to minimize the gas that enters the material collecting pipe 4. A baffle 19 encloses a lower end of the material collecting pipe 4 and an upper end of the baffle 19 is submerged below the liquid level of the gas-liquid-solid three-phase slurry reactor 3-2. The baffle 19 can prevent bubbles from entering the enclosed area from a lower portion or a horizontal direction. A lower end of the baffle 19 is provided with a gap having a specific area, such that a settled solid catalyst in the enclosed area can automatically return to the area below the baffle to continue to participate in the chemical reaction. The bubbles sucked into the enclosed area from above the baffle will gather and grow, and finally escape from the enclosed area without reaching the area at the lower end of the material collecting pipe 4. This significantly reduces the gas entering the material collecting pipe 4 and can reduce the load on the automatic liquid level control system 12 and improve the separation efficiency and separation accuracy.

In addition, the liquid level detection and analysis system 13 and the suction pump 14 are electrically connected, and are existing structural components. For example, the liquid level detection and analysis system 13 may be composed of signal connection between an existing liquid level detector and a micro-control system. The specific structures and working principles of the liquid level detection and analysis system 13 and the suction pump 14 pertain to the prior art and subject to the implementation of solution functions of this example, which will not be described in detail here.

It should be noted that it is obvious to those skilled in the art that the disclosure is not limited to the details of the foregoing exemplary examples, and that the disclosure can be implemented in other specific forms without departing from the spirit or basic features of the disclosure. Therefore, the examples should be regarded as exemplary and non-limiting in every respect, and the scope of the disclosure is defined by the appended claims rather than the foregoing description, and all changes falling within the meaning and scope of equivalent elements of the claims should be included in the disclosure. Any reference numeral in the claims should not be regarded as limiting the claims involved.

Specific examples are used for illustration of the principles and implementations of the disclosure. The description of the foregoing examples is only used to help illustrate the method and its core ideas of the disclosure. In addition, persons of ordinary skill in the art can make various modifications in terms of specific implementations and scope of application in accordance with the teachings of the disclosure. In conclusion, the content of this description shall not be construed as a limitation to the disclosure.

1. A method for extracting a clean liquid from a slurry reactor, comprising the following steps:
S1: sucking slurry from the slurry reactor into a material collecting pipe, and then spraying the slurry into a settling tank, so that solid particles settle in the settling tank and return to the slurry reactor through a discharging pipe;
S2: making supernatant in the settling tank flow upward along a settling pipe, and then flow downward at a pipe intersection into a clear liquid pipe;
S3: making the supernatant in the clear liquid pipe flow into a clear liquid transition tank, discharging the clean liquid from the clear liquid transition tank in an overflow mode, and collecting the clean liquid by a clean liquid storage tank; and
S4: introducing gas in the material collecting pipe into an escape pipe at the pipe intersection and continuously discharging the gas to ensure that the liquid level in the escape pipe is always higher than the pipe intersection, so that the slurry reactor and the clear liquid transition tank are always communicated and the liquid levels are the same.

2. The method for extracting a clean liquid from a slurry reactor according to claim 1, wherein in step S1, the slurry in the slurry reactor is sucked into the material collecting pipe in a siphon manner.

3. The method for extracting a clean liquid from a slurry reactor according to claim 1, wherein in step S1, the slurry in the material collecting pipe first rises vertically and then falls obliquely, and the particles in the discharging pipe fall vertically; the slurry in the material collecting pipe and the slurry in the discharging pipe have a density difference due to different solid contents, thereby forming a directional circulating flow, so that the settled solid particles can quickly return to the slurry reactor.

4. The method for extracting a clean liquid from a slurry reactor according to claim 2, wherein in step S4, it is necessary to keep the slurry reactor always communicated with the clear liquid transition tank, so that the liquid levels thereof are the same to ensure that the slurry can be siphoned.

5. The method for extracting a clean liquid from a slurry reactor according to claim 2, wherein in step S4, it is necessary to keep the liquid level in the clear liquid transition tank constant, so as to maintain the power required for siphoning.

6. A device for extracting a clean liquid from a slurry reactor which can implement the method for extracting a clean liquid from a slurry reactor according claim 1, comprising a material collecting pipe, a settling tank, a clear liquid transition tank, a clean liquid storage tank and an automatic liquid level control system, wherein a bottom end of the material collecting pipe is inserted below the liquid level of the slurry reactor, and a top end thereof is bent downwards and communicated with a lower portion of the settling tank; a bottom end of the settling tank is connected to a discharging pipe, and a bottom end of the discharging pipe is inserted below the liquid level of the slurry reactor; a top end of the settling tank is connected to a settling pipe, and the settling pipe is connected to a clear liquid pipe and an escape pipe at the same time to form a pipe intersection; the other end of the clear liquid pipe is inserted below the liquid level of the clear liquid transition tank, and the clear liquid transition tank is connected to the clean liquid storage tank through an overflow pipe; the other end of the escape pipe is connected to the automatic liquid level control system, and the automatic liquid level control system is configured to detect and adjust the liquid level in the escape pipe; the material collecting pipe is communicated with the settling pipe through a pipeline.

7. The device for extracting a clean liquid from a slurry reactor according to claim 6, wherein the slurry reactor is a liquid-solid two-phase slurry reactor; the top of the liquid-solid two-phase slurry reactor is provided with a feeding valve, the bottom thereof is provided with a liquid distributor, and the liquid distributor is connected to a fresh liquid inlet pipe.

8. The device for extracting a clean liquid from a slurry reactor according to claim 6, wherein the slurry reactor is a gas-liquid-solid three-phase slurry reactor; the top of the gas-liquid-solid three-phase slurry reactor is provided with a feeding valve and a deflating valve, the bottom thereof is provided with a gas distributor, and the gas distributor is connected to a gas inlet pipe; a side of the bottom of the gas-liquid-solid three-phase slurry reactor is connected to a fresh liquid inlet pipe.

9. The device for extracting a clean liquid from a slurry reactor according to claim 16, wherein an inner wall of the gas-liquid-solid three-phase slurry reactor is provided with a baffle, the baffle surrounds a lower end of the material collecting pipe and is submerged below the liquid level, and a bottom end of the baffle is provided with a gap.

10. The device for extracting a clean liquid from a slurry reactor according to claim 6, wherein the settling pipe, the clear liquid pipe and the escape pipe are connected through a tee structure.

11. A device for extracting a clean liquid from a slurry reactor which can implement the method for extracting a clean liquid from a slurry reactor according to claim 2, comprising a material collecting pipe, a settling tank, a clear liquid transition tank, a clean liquid storage tank and an automatic liquid level control system, wherein a bottom end of the material collecting pipe is inserted below the liquid level of the slurry reactor, and a top end thereof is bent downwards and communicated with a lower portion of the settling tank; a bottom end of the settling tank is connected to a discharging pipe, and a bottom end of the discharging pipe is inserted below the liquid level of the slurry reactor; a top end of the settling tank is connected to a settling pipe, and the settling pipe is connected to a clear liquid pipe and an escape pipe at the same time to form a pipe intersection; the other end of the clear liquid pipe is inserted below the liquid level of the clear liquid transition tank, and the clear liquid transition tank is connected to the clean liquid storage tank through an overflow pipe; the other end of the escape pipe is connected to the automatic liquid level control system, and the automatic liquid level control system is configured to detect and adjust the liquid level in the escape pipe; the material collecting pipe is communicated with the settling pipe through a pipeline.

12. A device for extracting a clean liquid from a slurry reactor which can implement the method for extracting a clean liquid from a slurry reactor according to claim 3, comprising a material collecting pipe, a settling tank, a clear liquid transition tank, a clean liquid storage tank and an automatic liquid level control system, wherein a bottom end of the material collecting pipe is inserted below the liquid level of the slurry reactor, and a top end thereof is bent downwards and communicated with a lower portion of the settling tank; a bottom end of the settling tank is connected to a discharging pipe, and a bottom end of the discharging pipe is inserted below the liquid level of the slurry reactor; a top end of the settling tank is connected to a settling pipe, and the settling pipe is connected to a clear liquid pipe and an escape pipe at the same time to form a pipe intersection; the other end of the clear liquid pipe is inserted below the liquid level of the clear liquid transition tank, and the clear liquid transition tank is connected to the clean liquid storage tank through an overflow pipe; the other end of the escape pipe is connected to the automatic liquid level control system, and the automatic liquid level control system is configured to detect and adjust the liquid level in the escape pipe; the material collecting pipe is communicated with the settling pipe through a pipeline.

13. A device for extracting a clean liquid from a slurry reactor which can implement the method for extracting a clean liquid from a slurry reactor according to claim 4, comprising a material collecting pipe, a settling tank, a clear liquid transition tank, a clean liquid storage tank and an automatic liquid level control system, wherein a bottom end of the material collecting pipe is inserted below the liquid level of the slurry reactor, and a top end thereof is bent downwards and communicated with a lower portion of the settling tank; a bottom end of the settling tank is connected to a discharging pipe, and a bottom end of the discharging pipe is inserted below the liquid level of the slurry reactor; a top end of the settling tank is connected to a settling pipe, and the settling pipe is connected to a clear liquid pipe and an escape pipe at the same time to form a pipe intersection; the other end of the clear liquid pipe is inserted below the liquid level of the clear liquid transition tank, and the clear liquid transition tank is connected to the clean liquid storage tank through an overflow pipe; the other end of the escape pipe is connected to the automatic liquid level control system, and the automatic liquid level control system is configured to detect and adjust the liquid level in the escape pipe; the material collecting pipe is communicated with the settling pipe through a pipeline.

14. A device for extracting a clean liquid from a slurry reactor which can implement the method for extracting a clean liquid from a slurry reactor according to claim 5, comprising a material collecting pipe, a settling tank, a clear liquid transition tank, a clean liquid storage tank and an automatic liquid level control system, wherein a bottom end of the material collecting pipe is inserted below the liquid level of the slurry reactor, and a top end thereof is bent downwards and communicated with a lower portion of the settling tank; a bottom end of the settling tank is connected to a discharging pipe, and a bottom end of the discharging pipe is inserted below the liquid level of the slurry reactor; a top end of the settling tank is connected to a settling pipe, and the settling pipe is connected to a clear liquid pipe and an escape pipe at the same time to form a pipe intersection; the other end of the clear liquid pipe is inserted below the liquid level of the clear liquid transition tank, and the clear liquid transition tank is connected to the clean liquid storage tank through an overflow pipe; the other end of the escape pipe is connected to the automatic liquid level control system, and the automatic liquid level control system is configured to detect and adjust the liquid level in the escape pipe; the material collecting pipe is communicated with the settling pipe through a pipeline.

15. The device for extracting a clean liquid from a slurry reactor according to claim 11, wherein the slurry reactor is a liquid-solid two-phase slurry reactor; the top of the liquid-solid two-phase slurry reactor is provided with a feeding valve, the bottom thereof is provided with a liquid distributor, and the liquid distributor is connected to a fresh liquid inlet pipe.

16. The device for extracting a clean liquid from a slurry reactor according to claim 12, wherein the slurry reactor is a liquid-solid two-phase slurry reactor; the top of the liquid-solid two-phase slurry reactor is provided with a feeding valve, the bottom thereof is provided with a liquid distributor, and the liquid distributor is connected to a fresh liquid inlet pipe.

17. The device for extracting a clean liquid from a slurry reactor according to claim 13, wherein the slurry reactor is a liquid-solid two-phase slurry reactor; the top of the liquid-solid two-phase slurry reactor is provided with a feeding valve, the bottom thereof is provided with a liquid distributor, and the liquid distributor is connected to a fresh liquid inlet pipe.

18. The device for extracting a clean liquid from a slurry reactor according to claim 14, wherein the slurry reactor is a liquid-solid two-phase slurry reactor; the top of the liquid-solid two-phase slurry reactor is provided with a feeding valve, the bottom thereof is provided with a liquid distributor, and the liquid distributor is connected to a fresh liquid inlet pipe.

19. The device for extracting a clean liquid from a slurry reactor according to claim 11, wherein the slurry reactor is a gas-liquid-solid three-phase slurry reactor; the top of the gas-liquid-solid three-phase slurry reactor is provided with a feeding valve and a deflating valve, the bottom thereof is provided with a gas distributor, and the gas distributor is connected to a gas inlet pipe; a side of the bottom of the gas-liquid-solid three-phase slurry reactor is connected to a fresh liquid inlet pipe.

20. The device for extracting a clean liquid from a slurry reactor according to claim 12, wherein the slurry reactor is a gas-liquid-solid three-phase slurry reactor; the top of the gas-liquid-solid three-phase slurry reactor is provided with a feeding valve and a deflating valve, the bottom thereof is provided with a gas distributor, and the gas distributor is connected to a gas inlet pipe; a side of the bottom of the gas-liquid-solid three-phase slurry reactor is connected to a fresh liquid inlet pipe.
